(19) United States
(12) Patent Application Publication
(10) Pub. No.: US 2016/0093846 A1
(43) Pub. Date: Mar. 31, 2016

(54) SEMI-RIGID BATTERY PACKS

(71) Applicant: Apple Inc., Cupertino, CA (US)

(72) Inventors: Julian Malinski, Miami Beach, FL (US); Richard Hung Minh Dinh, Saratoga, CA (US); Daniel W. Jarvis, Sunnyvale, CA (US)

(21) Appl. No.: 14/500,814

(22) Filed: Sep. 29, 2014

(51) Int. Cl. H01M 2/10

(52) U.S. Cl. CPC H01M 2/1066; H01M 2220/30

(57) ABSTRACT

An electronic device having a semi-rigid battery pack is disclosed. The semi-rigid battery pack offers an internal power supply with relatively high energy density (energy per volume) with a stiff cover covering the battery pack to shield other internal components from the battery pack. The cover may also be formed with a larger dimension than that of the battery pack such that when the battery pack undergoes a swelling event, the battery pack increases its volume while still be contained by the cover. In this manner, other internal components may be positioned proximate to the cover without being affected by the battery pack. In another embodiment, a mold member covers an outer peripheral portion and supports the battery pack while allowing the battery pack to undergo a swelling event.

### FIELD

The described embodiments relate generally to an electronic device. In particular, the present embodiments relate to enclosing an internal power supply within the electronic device.

### BACKGROUND

Certain battery packs may be a preferred internal power supply in electronic devices. These battery packs, sometimes known as “soft” battery packs, may include a chemical cell wrapped in a relatively non-rigid pouch. Soft battery packs offer high energy density (energy per volume) allowing electronic devices to, for example, operate over longer intervals between charges. The non-rigid pouch allows the battery pack to undergo a swelling event in which the battery pack increases in volume during use.

However, the soft battery pack may include several drawbacks. For instance, when the battery pack undergoes a swelling event, the volume of the battery pack may increase in a direction toward other internal components, causing unwanted contact with the internal components. Also, the additional heat generated during the swelling event may be transferred to sensitive internal components even in the absence of contact. In addition, if the electronic device is dropped, the non-rigid pouch allows additional unwanted movement of the battery pack. Several internal components must therefore be positioned at a distance from the battery pack as a means to prevent damage. Consequently, the internal configurations of the electronic device may be less flexible.

### SUMMARY

In one aspect, an electronic device is described. The electronic device may include a securing member having several sidewalls. In some cases, the several sidewalls include a securing means to an enclosure of the electronic device. The electronic device may further include an expandable internal power supply secured to the top portion. The electronic device may further include a gap between the expandable internal power supply and the enclosure.

In another aspect, a method for securing an internal power supply to an enclosure of an electronic device is described. The method may include positioning the internal power supply within a securing member. The method may further include fastening the securing member to the enclosure. The method may further include suspending the internal power supply from an interior portion of the securing member. The method may further include forming a gap between the internal power supply and the enclosure.

In another aspect, an electronic device configured to compensate for a swelling event of an internal power supply is described. The electronic device may include a securing member having a top portion and several sidewalls integrally formed with the top portion. In some embodiments, the several sidewalls include a first sidewall and a second sidewall. The electronic device may further include an enclosure having a boss. The electronic device may further include a fastener that extends through an extension of the first sidewall and the boss. Also, the electronic device may further include a means for securing the internal power supply to the top portion. In some embodiments, the internal power supply positioned between the top portion and the enclosure. In some embodiments, the first sidewall includes a first height. Also, in some embodiments, the internal power supply combined with the means for securing the internal power supply include a second height less than the first height to define a gap allowing for the swelling event of the internal power supply. Also, the enclosure may include a cavity which defines a second gap greater than the gap.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an isometric view of an embodiment of an electronic device;

FIG. 2 illustrates an exploded view of the embodiment of the electronic device shown in FIG. 1;

FIG. 3 illustrates a top view of the electronic device shown in FIG. 1, with the cover glass and several internal components removed;

FIG. 4 illustrates a cross sectional view of the embodiment shown in FIG. 3, taken along the line 4-4;

FIG. 5 illustrates a cross sectional view of the embodiment shown in FIG. 4, with the internal power supply undergoing a swelling event;

FIG. 6 illustrates a cross sectional view of another embodiment of an electronic device using another material to suspend the internal power supply from the cover;

FIG. 7 illustrates an exploded view of another embodiment of an electronic device having an internal power supply positioned within a securing member;

FIG. 8 illustrates a top view of an embodiment of an electronic device with an internal power supply and a securing member secured to an enclosure;

FIG. 9 illustrates a cross sectional view of the embodiment shown in FIG. 8, taken along the line 9-9;

FIG. 10 illustrates a cross sectional view of the embodiment shown in FIG. 9, with the internal power supply undergoing a swelling event;

FIG. 11 illustrates an alternate embodiment of an electronic device having an internal power supply secured to an enclosure by a securing member and an adhesive layer;

FIG. 12 illustrates a cross sectional view of the embodiment shown in FIG. 11, with the internal power supply undergoing a swelling event; and

FIG. 13 illustrates a flowchart showing a method for securing an internal power supply to an enclosure of an electronic device.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments may be used, and changes may be made without departing from the spirit and scope of the described embodiments.

The following disclosure relates to a semi-rigid battery pack in an electronic device. The semi-rigid battery pack may be a six-sided structure which includes a battery cell enclosed within a non-rigid pouch. A securing member may enclose five of the six sides of the semi-rigid battery pack with the enclosure of an electronic device offering support on the remaining sixth side. The securing member may be made from rigid materials (e.g., metal, plastic) that provide protection against drop events. In addition, the securing member allows the semi-rigid battery pack may undergo a swelling event in which the semi-rigid battery pack increases in volume due in part to increased temperatures of the semi-rigid battery pack.

The securing member may include at least a dimension larger than that of the semi-rigid battery pack. In this manner, when the semi-rigid battery pack undergoes the swelling event, it may do within the confines of the securing member. Moreover, rather than allowing the semi-rigid battery pack to swell in a direction toward internal components of the electronic device, the semi-rigid battery pack may swell within the additional dimension provided for by the securing member and the enclosure. This additional dimensional may be in a location away from the internal components, such as a direction toward the enclosure. As a result, the electronic device may include a battery pack having a greater energy density along with physical and thermal isolation from internal components.

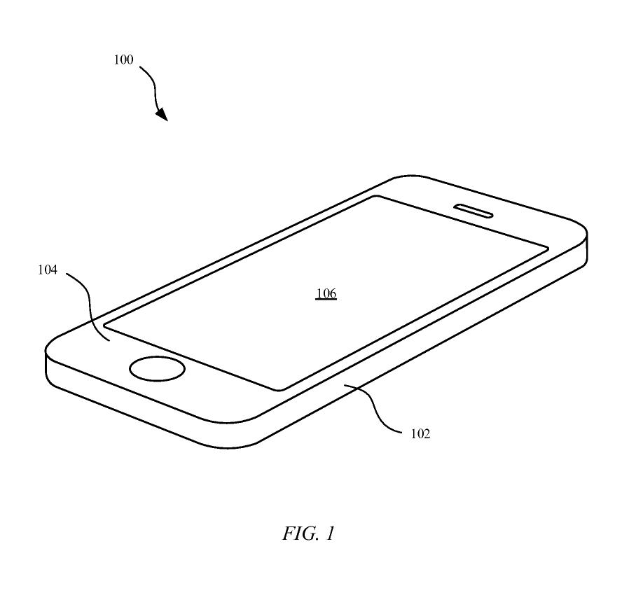

These and other embodiments are discussed below with reference to FIGS. 1-13. However, those skilled in the art will readily appreciate that the detailed description given herein with respect to these Figures is for explanatory purposes only and should not be construed as limiting.

FIG. 1 illustrates an embodiment of an electronic device 100. In some embodiments, electronic device 100 is a tablet computing device, such as an iPad® from Apple Inc., of Cupertino, Calif. In other embodiments, electronic device 100 is mobile communications device, such as an iPhone® from Apple Inc., of Cupertino, Calif. Electronic device 100 includes enclosure 102 that receives cover glass 104. In some embodiments, enclosure 102 is made from a metal, such as aluminum. Display panel 106 may be positioned between enclosure 102 and cover glass 104, and may also drive visual display content visible through cover glass 104.

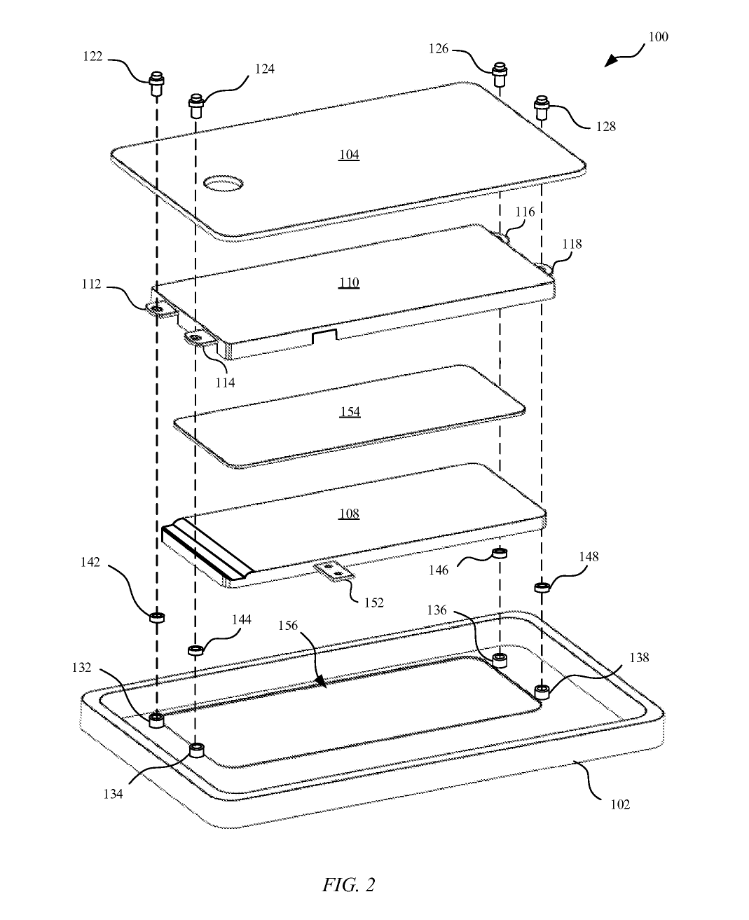

FIG. 2 illustrates an exploded view of the embodiment of electronic device 100 shown in FIG. 1. For purposes of clarity, several internal components (e.g., processors, memory circuits, antenna, etc.) are removed. In additional to enclosure 102 and cover glass 104, electronic device 100 may include internal power supply 108. In some embodiments, internal power supply 108 is a batter that includes a relatively non-rigid pouch or sleeve that receives a chemical cell. When electronic device 100 is in use, and in particular, when electronic device 100 relies upon internal power supply 108 to provide electrical current to the device 100, an internal power supply 108 may rely upon a chemical reaction within the chemical cell causing the internal power supply to expand during or after use. Internal power supply 108 may receive an electric charge from a power source (not shown) external with respect to electronic device 100, and hold the charge for use with other internal components.

Electronic device 100 may further include securing member 110. In some embodiments, securing member 110 is configured as a cover made from a rigid material, such as plastic. In the embodiment shown in FIG. 2, securing member 110 is made from sheet metal. Generally, securing member 110 may be made from any relatively rigid or stiff material(s). Securing member 110 may include several extensions. As shown in FIG. 2, securing member 110 includes first extension 112, second extension 114, third extension 116, and fourth extension 118. These extensions may receive several fasteners. For example, first extension 112, second extension 114, third extension 116, and fourth extension 118 may receive first fastener 122, second fastener 124, third fastener 126, and fourth fastener 128, respectively. These fasteners may be removably secured to several bosses located on an interior portion of enclosure 102. “Removably secured” as used throughout this detailed description and in the claims refers to a structure which is not permanently secured to another structure and may be removed without damaging other structures. For example, the bosses may include internal threads that receive threaded portions of the fasteners such that the fasteners may be removed, if desired, with a tool.

In FIG. 2, first fastener 122, second fastener first fastener 122, second fastener 124, third fastener 126, and fourth fastener 128 may be secured to enclosure 102 via first boss 132, second boss 134, third boss 136, and fourth boss 138, respectively. These bosses may be integrally formed with enclosure 102 by a material removal process using a machine tool, such as a computer numeric control (“CNC”) tool, that removes material from a substrate (e.g., aluminum substrate) to form the bosses. Also, in some embodiments, washers may be used to further secure the fasteners to the bosses. FIG. 2 shows first washer 142, second washer 144, third washer 146, and fourth washer 148 may be configured to secure first fastener 122, second fastener 124, third fastener 126, and fourth fastener 128, respectively. In other embodiments, the fasteners and bosses include a snap-fit relationship. In either event, securing member 110 may be easily secured to and removed from enclosure 102 using a tool, such as a screwdriver. This allows for internal power supply 108 to be replaced if damaged. In order to further secure power supply 108 to enclosure 102, in some embodiments, power supply 108 includes connector 152 that extends through opening 158 of securing member 110. Also, adhesive layer 154 includes an adhesive portion on at least two sides such that power supply 108 is adhesively secured to securing member 110.

Securing member 110 may include a dimension larger than power supply 108 such that when power supply 108 is adhesively secured to securing member 110 and securing member 110 is fastened to enclosure, power supply 108 does not contact enclosures 102. This allows power supply 108 to increase in volume (e.g., swell) in the space or void between power supply 108 and enclosure 102. In some cases, power supply 108 may swell such that the overall volume increases by 6-10%. To further compensate for the swell, in some embodiments, enclosure 102 may include cavity 156 defined as additional material removed in order to accommodate volume increases of power supply 108.

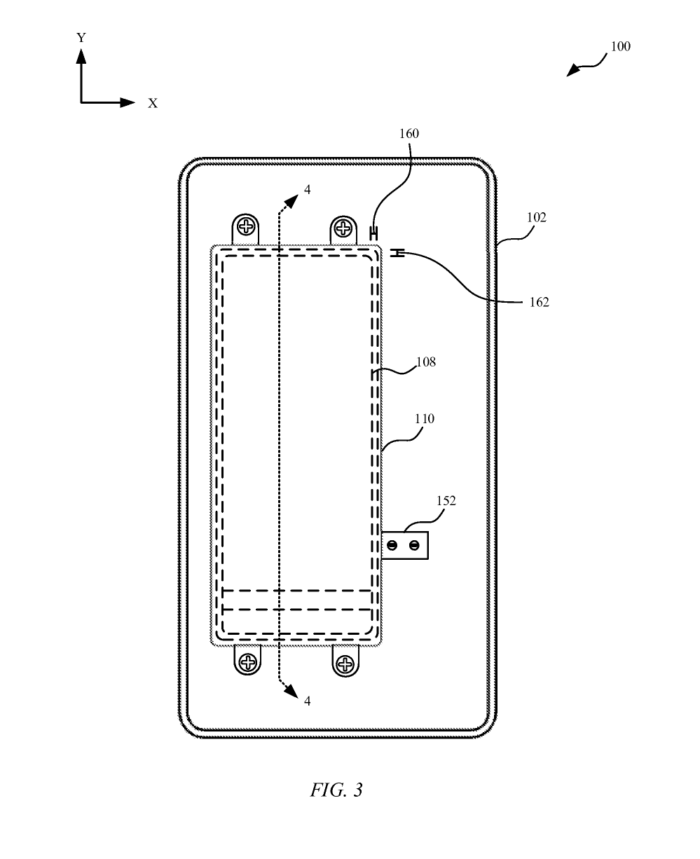

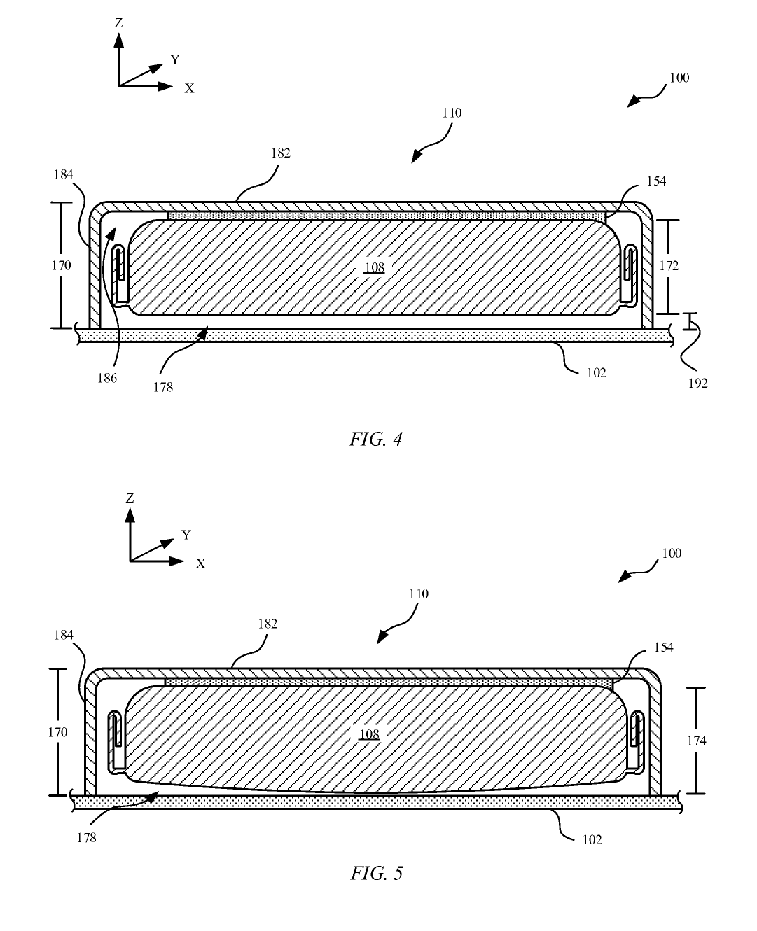

FIGS. 3 and 4 illustrate electronic device 100 shown in FIG. 2 with the various components assembled. FIG. 3 illustrates a top view of electronic device 100 shown in FIG. 1, with cover glass 104 and several internal components removed. As shown, power supply 108 is positioned within securing member 110 and secured to enclosure 102 by the fasteners. It should be understood that despite any swelling event previously described, power supply 108 may remain positioned within the confines of securing member 110. As such, electronic device 100 may include several other internal components positioned in a manner such that power supply 108 will not affect the internal components, either physically or thermally. Also, securing member 110 may include a dimension such that securing member 110 is separated from power supply 108 a distance 160 in the x-direction and a distance 162 in the y-direction, both of which are approximately in the range of 0.2 to 0.4 millimeters.

Because internal power supply 108 is generally surrounded by either securing member 110 or enclosure 102, enclosure 102 may include connectors (not shown) which electrically connect to connectors (not shown) of internal power supply 108. In this manner, internal power supply 108 may receive electrical charge from an external source as well as supply electric charge to internal components. Also, in some embodiments, connector 152 includes electrically connective features for internal power supply 108.

FIG. 4 illustrates a cross sectional view of the embodiment of electronic device 100 shown in FIG. 3, taken along the line 4-4. In some embodiments, securing member 110 includes top portion 182 and an exemplary sidewall 184, with sidewall 184 having a dimension greater than that of power supply 108. For example, sidewall 184 includes height 170 in the z-direction greater than height 172 of power supply 108 plus a height of adhesive layer 154 used to adhesively secure power supply 108 to interior portion 186 of securing member 110. As a result, a gap 178 between power supply 108 and enclosure 102 may be formed. Gap 178 may also be referred to as a space void of any structure. Also, gap 178 may include a dimension 192 approximately in the range of 0.1 to 0.3 millimeters. It will be appreciated that some features are not drawn to scale and may be exaggerated to show detail. Gap 178 may also represent a volume sufficient to allow power supply 108 to undergo a swell event, as shown in FIG. 5, in which power supply 108 increases to height 174 greater than height 172 without contacting enclosure 102. Although not shown, enclosure 102 may include a cavity (as shown in FIG. 2) to either allow for additional swelling of power supply 108 or reduce height 170 of sidewall 184 in order to reduce internal space within electronic device 100 occupied by securing member 110. Also, although not all sidewalls are shown, it should be understood that the height of the sidewalls are substantially similar to height 170 of sidewall 184.

FIG. 4 also shows internal power supply 108 having a first size, while FIG. 5 shows internal power supply 108 having a second size, due in part to a swelling event. Gap 178 may therefore be referred to as a volume which receives a difference between the first size of the internal power supply 108 and the second size of the internal power supply 108. Also, because internal power 108 is adhesively secured to securing member 110, internal power supply 108 may be suspended from securing member 110. Further, in some embodiments, internal power supply 108 does directly contact securing member 110 and enclosure 102 (as shown in FIGS. 3-5), and accordingly, internal power supply 108 is free of contact with securing member 110 and enclosure 102. This may further allow for drop events of electronic device 100 such that internal power supply 108 does not contact securing member 110 and/or enclosure 102 which may reduce damage to internal power supply 108.

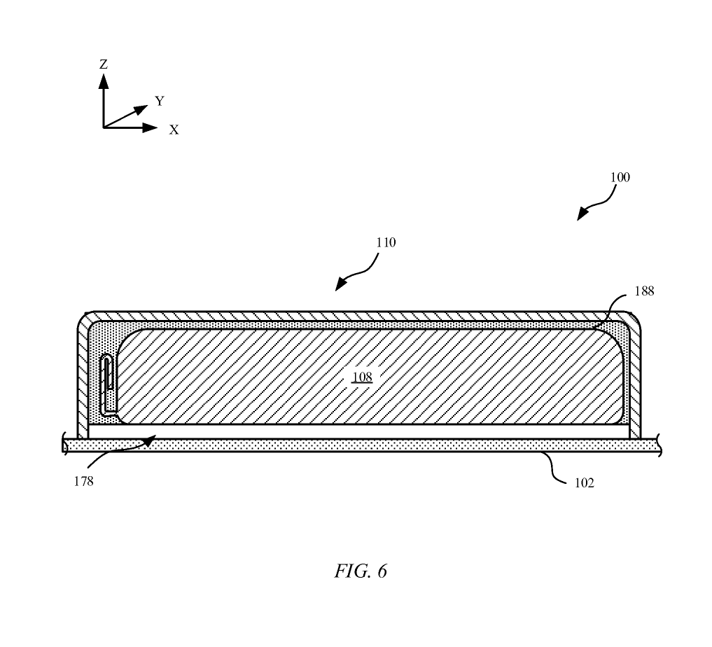

FIG. 6 illustrates a cross sectional view of another embodiment of electronic device 100 having material 188 suspending internal power supply 108 from securing member 110. In some embodiments, material 188 is an adhesive fill. Generally, material 188 may be formed from any material, including a potting material, known in the art for potting electronic devices. Material 188 may still allow for gap 178 between power supply 108 and enclosure 102.

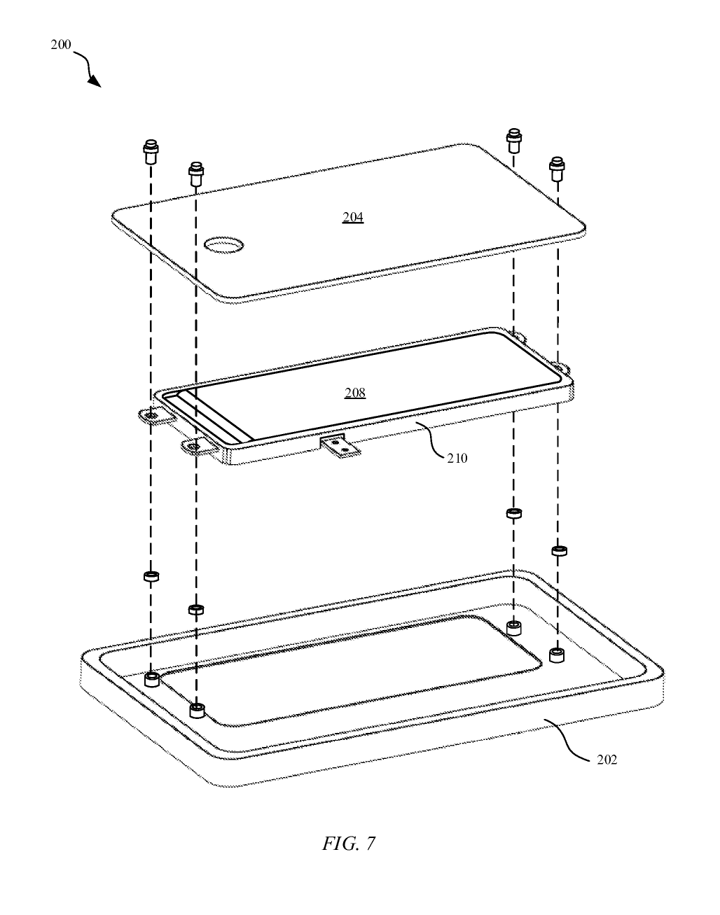

FIG. 7 illustrates an exploded view of an alternative embodiment of electronic device 200 having enclosure 202 and cover glass 204, with securing member including several sidewalls extending around lateral portions of internal power supply 208. In some embodiments, securing member 210 is a molded member formed from materials such as ethylene vinyl acetate (“EVA”), polyurethane, polyamides, metallocene polyalphaolefins, or a combination thereof. In some embodiments, securing member 210 is formed from Macromelt® from Henkel Corp., of Düsseldorf, Germany. In other embodiments, securing member 210 is made from Technomelt, including Technomelt Supra™ or Technomelt Extra™, from Henkel Corp., of Düsseldorf, Germany. Generally, securing member 210 is formed a rigid material or materials such that mold member does not extend in lateral directions due to forces from internal power supply 208. However, despite the rigid exterior of securing member 210, securing member 210 may have a compliant feature or features in locations engaged with internal power supply 208 such that the internal shape of securing member 210 corresponds to internal power supply 208. Internal power supply 208 may be secured to enclosure 202 by fastening securing member 210 to enclosure in a manner previously described, that is, using fasteners to pass through extensions of securing member 210 with the extensions secured to the bosses (as shown in FIG. 7).

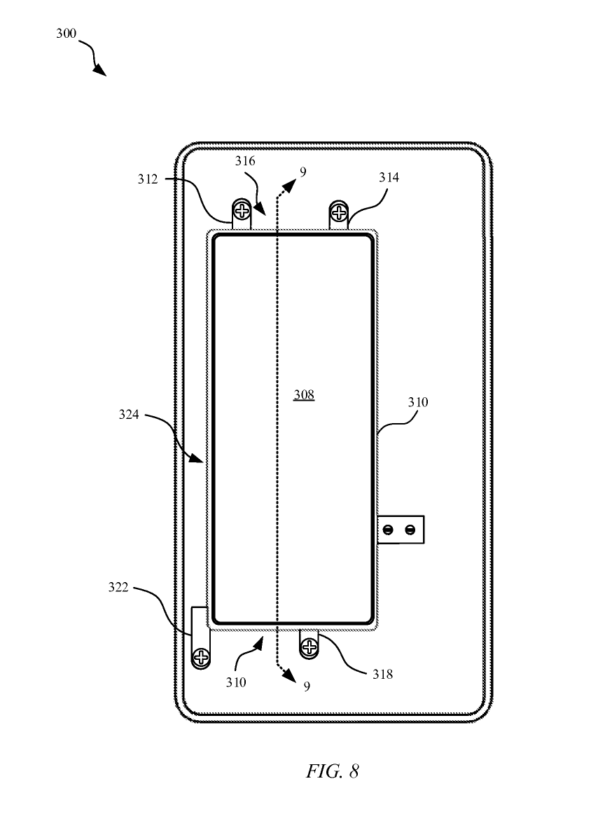

FIG. 8 illustrates a top view of electronic device 300 with internal power supply 308 secured to enclosure 302 by an alternative embodiment of securing member 310. In some embodiments, securing member 310 includes a pair of extensions on a sidewall with another pair of extensions on an opposing sidewall. In the embodiment shown in FIG. 8, mold member includes first extension 312 and second extension 314 on a first sidewall 316, third extension 318 on second sidewall 320, and fourth extension 322 on third sidewall 324. In other embodiments, each sidewall includes at least one extension. Also, the extensions may be configured to receive fasteners previously described in order to secure securing member 310 and internal power supply 308 to enclosure 302 via bosses (not shown).

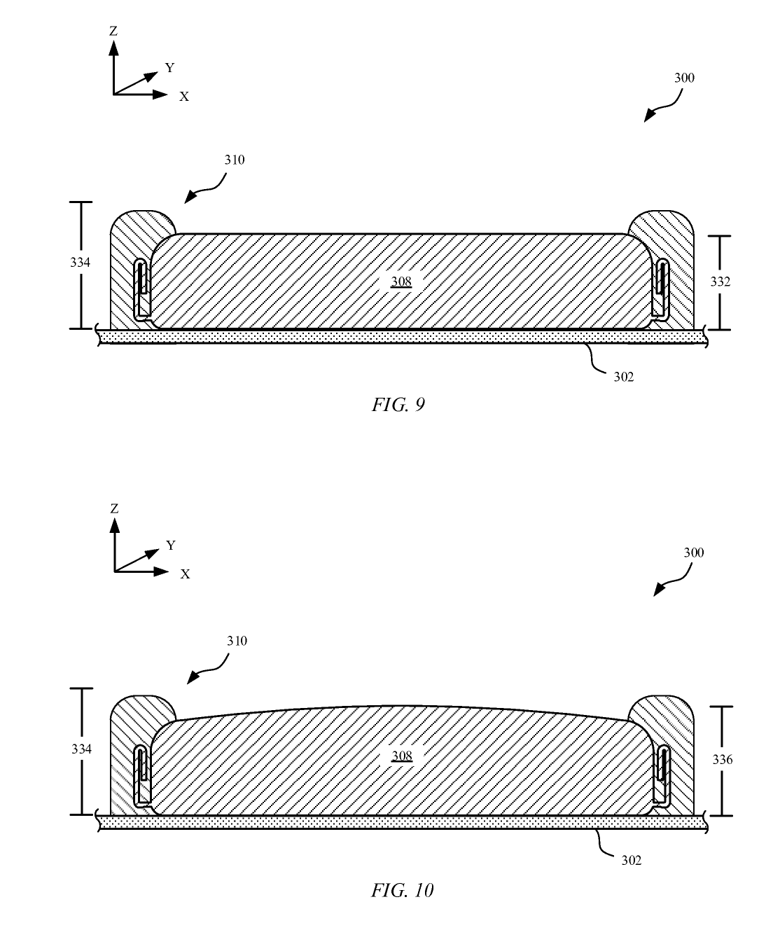

FIG. 9 illustrates a cross sectional view of the embodiment of electronic device 300 shown in FIG. 8, taken along the line 9-9. Securing member 310 may be made from any material previously described for securing member 210 (shown in FIG. 7), and may provide a rigid body such that internal power supply 308 generally does not force securing member 310 to extend laterally (e.g., x-direction and/or y-direction) during a swelling event of internal power supply 308. Also, in some embodiments, internal power supply 308 is suspended, that is, not engaged with enclosure 302. In the embodiment shown in FIG. 9, internal power supply 308 is positioned on enclosure 302. Prior to a swelling event, internal power supply 308 includes a height 332 in the z-direction less than height 334 of securing member 310. However, FIG. 10 illustrates a cross sectional view of the embodiment shown in FIG. 9, with internal power supply 308 undergoing a swelling event such that internal power supply 308 extends in the z-direction in a direction away from enclosure 302 to a height 336 greater than height 332. Despite the swelling event, height 336 is ultimately less than height 334 of securing member 310. As a result, other internal components (not shown) may be positioned proximate to securing member 310 without internal power supply 308 affecting the internal components physically or thermally.

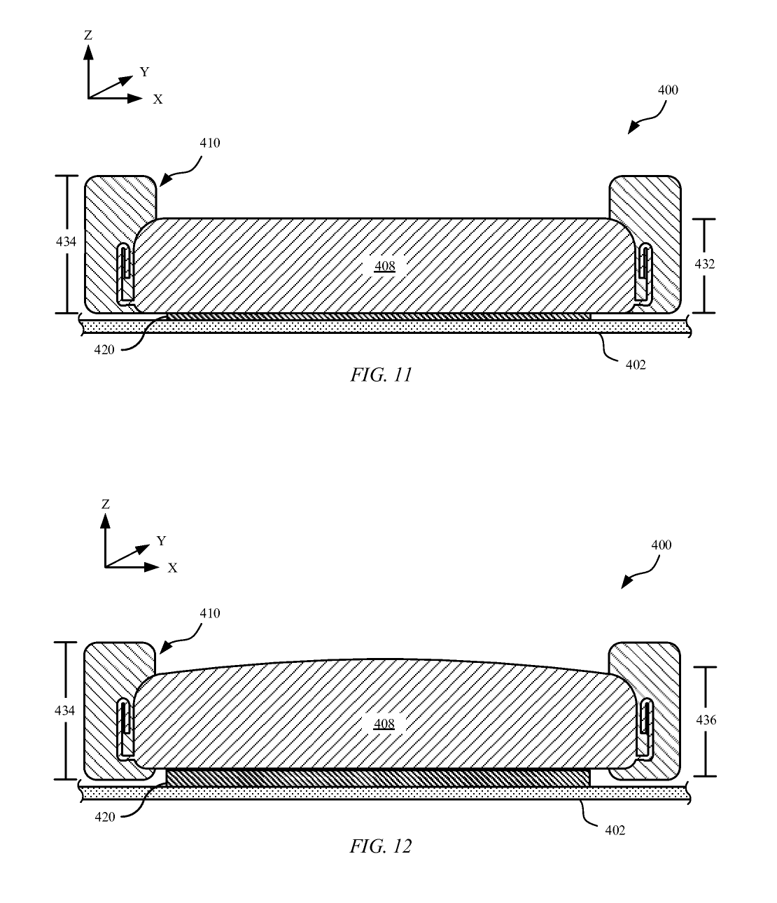

FIG. 11 illustrates an alternate embodiment of electronic device 400 having internal power supply 408 secured to enclosure 402 by securing member 410 and an adhesive layer 420. Securing member 410 may be made from any material previously described for mold member 210, and may provide a rigid body such that internal power supply 408 generally does not force securing member 410 to extend laterally (e.g., x-direction and/or y-direction) during a swelling event of internal power supply 408. Prior to a swelling event, internal power supply 408 includes a height 432 in the z-direction less than height 434 of securing member 410. However, FIG. 12 illustrates a cross sectional view of the embodiment shown in FIG. 11, with internal power supply 408 undergoing a swelling event such that internal power supply 408 extends in the z-direction in a direction away from enclosure 402 to a height 436 greater than height 432. Despite the swelling event, height 436 is ultimately less than height 434 of securing member 410. As a result, other internal components (not shown) may be positioned proximate to securing member 410 without internal power supply 408 affecting the internal components physically or thermally.

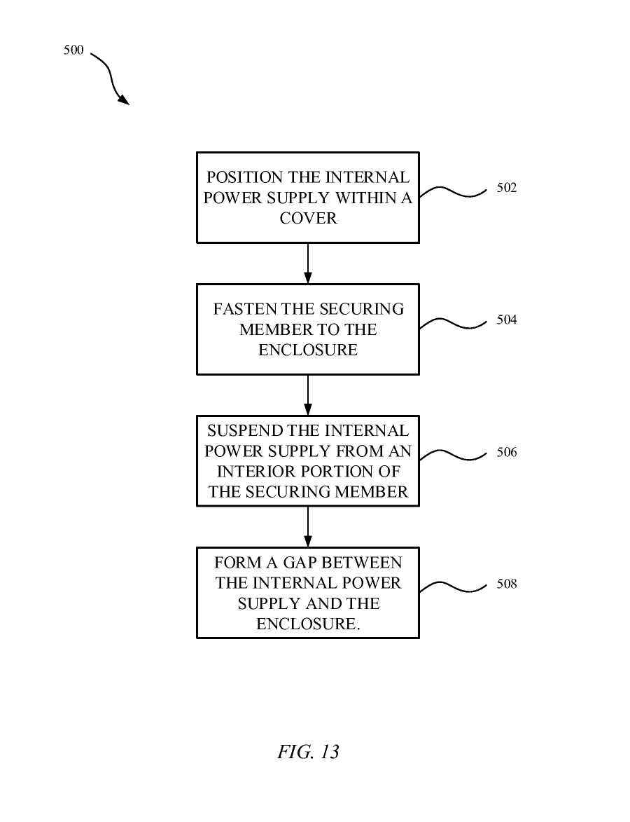

FIG. 13 illustrates a flowchart 500 showing a method for securing an internal power supply to an enclosure of an electronic device. In step 502, the internal power supply is positioned within a cover. In some embodiments, the cover includes four sidewalls such that the cover and the side walls confine the internal power supply. Further, in some embodiments, the sidewalls include a height (in the z-direction) greater than that of the internal power supply prior to a swelling event. In step 504, the securing member is fastened to the enclosure. Fastening means may include several fasteners extending through extensions of the cover, and also extending through bosses on the enclosure. In some embodiments, the bosses are internally threaded to receive the fasteners which are also threaded. In step 506, the internal power supply is suspended from an interior portion of the securing member. In step 508, a gap is formed between the internal power supply and the enclosure. The gap, or space, is configured to allow the internal power supply to undergo a swelling event which includes increasing the volume of the internal power supply, for example, when the internal power supply generates heat during use. In this manner, internal components proximate to the internal power supply are not affected physically or thermally. This may be due in part to the securing member acting as a thermal shield for the internal components, or by forcing the internal power supply to extend in a direction away from the internal components.

The aforementioned embodiments offer several other advantages. For example, the internal power supply (e.g., power supply 108) may provide additional support and rigidity to the electronic device (e.g., electronic device 100). This may be due in part to the internal power supply resisting twisting and/or bending of the enclosure by forces external to the enclosure. Further, the fasteners of the cover (e.g., securing member 110) or securing member (e.g., securing member 310) along with the connector of the internal power supply allow for easy removal of the securing member and power supply assembly, particularly in embodiments in which the internal power supply is not adhesively secured to the enclosure.

Further, the internal power supply, having a relatively non-rigid outer pouch or sleeve, may now be positioned in a location within the electronic device with greater certainty. In other words, the non-rigid battery pack is positioned within a rigid body which is generally stationary with respect to the electronic device. As a result, the relatively “loose” tolerances of the internal power supply, due in part to the non-rigid pouch, are now positioned within a rigid body with a relatively tight tolerance so that other internal components may be positioned within the electronic device with being affected by the internal power supply. Also, a rigid body with tight, or small, tolerances may allow an electronic device with an internal power supply with a greater initial volume, that is, prior to swelling. This allows for an internal power supply with a greater energy supply. Also, the internal power supply positioned within the securing member may be more resistant to a puncturing event, for example, during an assembly process by tool such as a screwdriver.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device, comprising:
a securing member having a plurality of sidewalls, the plurality of sidewalls comprising securing means to an enclosure of the electronic device;
an expandable internal power supply secured to a top portion of the securing member; and
a gap between the expandable internal power supply and the enclosure.

2. The electronic device as recited in claim 1, further comprising an adhesive layer positioned between the top portion and the internal power supply.

3. The electronic device as recited in claim 2, wherein the internal power supply is a battery that increases from a first size to a second size greater than the first size, and wherein the gap receives a difference between the second size and the first size.

4. The electronic device as recited in claim 3, the plurality of sidewalls comprising a first sidewall having a height greater than the height of the internal power supply having the second size.

5. The electronic device as recited in claim 1, the plurality of sidewalls comprising a first sidewall having an extension.

6. The electronic device as recited in claim 5, the securing means comprising a fastener and a boss, the boss integrally formed with the enclosure, and wherein the fastener extends through the extension and is removably secured to the boss.

7. The electronic device as recited in claim 1, wherein the securing member is molded around lateral portion of the expandable internal power supply.

8. The electronic device as recited in claim 1, the expandable internal power supply comprising a connecter extending through the securing member, the connector secured to the enclosure.

9. A method for securing an internal power supply to an enclosure of an electronic device, the method comprising:
positioning the internal power supply within a securing member;
fastening the securing member to the enclosure;
suspending the internal power supply from an interior portion of the securing member; and
forming a gap between the internal power supply and the enclosure.

10. The method as recited in claim 9, further comprising positioning an adhesive layer between the interior portion of the securing member and the internal power supply.

11. The method as recited in claim 10, wherein the gap receives the internal power supply when the internal power supply increases from a first size to a second size greater than the first size.

12. The method as recited in claim 11, wherein fastening the securing member to the enclosure comprises fastening a fastener to a boss integrally formed with the enclosure, the fastener extending through an extension of the securing member.

13. The method as recited in claim 11, wherein the internal power supply is free of direct contact with the securing member.

14. The method as recited in claim 9, wherein the gap is configured to accommodate a swelling event of the internal power supply.

15. An electronic device configured to compensate for a swelling event of an internal power supply, the electronic device comprising:
a securing member, comprising:
a top portion; and
a plurality of sidewalls integrally formed with the top portion, the plurality of sidewalls having a first sidewall and a second sidewall;
an enclosure having a boss;
a fastener that extends through an extension of the first sidewall and the boss; and
means for securing the internal power supply to the top portion, the internal power supply positioned between the top portion and the enclosure, wherein:
the first sidewall includes a first height,
the internal power supply combined with the means for securing the internal power supply include a second height less than the first height to define a gap allowing for the swelling event of the internal power supply.

16. The electronic device as recited in claim 15, wherein the fastener is removably secured to the boss.

17. The electronic device as recited in claim 15, wherein the means for securing the internal power supply to the top portion comprises an adhesive layer.

18. The electronic device as recited in claim 17, wherein the internal power supply is free of direct contact with the securing member and the enclosure.

19. The electronic device as recited in claim 15, wherein the means for securing the internal power supply to the top portion comprises a potting material.

20. The electronic device as recited in claim 15, further comprising a cavity formed within the enclosure to define a second gap greater than the gap.
